(19) United States
(12) Patent Application Publication
(10) Pub. No.: US 2013/0250604 A1
(43) Pub. Date: Sep. 26, 2013

(54) LIGHT BAR-COMBINED REMOVABLE ZIPPER

(71) Applicants: HONG-HSU HUANG, TAIPEI CITY (TW); CHI-SHU KANG, TAIPEI CITY (TW); I-CHEN SU, TAIPEI CITY (TW); JUNG-HSIANG PENG, TAIPEI CITY (TW)

(72) Inventors: HONG-HSU HUANG, TAIPEI CITY (TW); CHI-SHU KANG, TAIPEI CITY (TW); I-CHEN SU, TAIPEI CITY (TW); JUNG-HSIANG PENG, TAIPEI CITY (TW)

(73) Assignee: KING'S METAL FIBER TECHNOLOGIES CO., LTD., TAICHUNG CITY (TW)

(21) Appl. No.: 13/425,526

(22) Filed: Mar. 21, 2012

(51) Int. Cl. F21V 1/06

(52) U.S. Cl. 362/555; 362/103

(57) ABSTRACT

The present invention relates to a light bar-combined removable zipper, which includes a first tape, a second tape, a light bar, and a controller. The second tape has an edge joinable to an edge of the first tape to constitute a removable zipper structure. The light bar is combined to the second tape. The controller is connected to the light bar to supply electrical power to and selectively activate/deactivate the lighting of the light bar.

### FIELD OF THE INVENTION

The present invention relates to a removable zipper with a light bar combined therewith, and in particular to a light bar-combined removable zipper for use in articles such as clothing and accessories.

### BACKGROUND OF THE INVENTION

A conventional zipper comprises a pair of woven tapes, a plurality of teeth, and a slider. The teeth are arranged along opposing edges of the two tapes to form mateable tooth rows. Stops are set at opposite ends of each tooth row. The tooth row of one of the tapes functions to guide a reciprocal sliding motion of the slider for combining or releasing the two tooth rows to form or break a closed chain of the zipper. Such an arrangement allows the conventional zippers to be applicable to wearable articles, such as clothes and trousers, to make the wearable articles readily put on/off by a user. Due to the potential marketability and sales of zippers, light-reflective zippers, which are particularly fit to nighttime use, are available, in which light-reflective filaments are twisted in combination with weft or warp yarns of the zipper tapes or alternatively, the zipper teeth are made of light reflective materials. Consequently, an effect of alarming can be realized through light reflection and this type of zipper is separated from the traditional zippers.

However, the tapes and/or teeth of the light-reflective zipper must be first irradiated by light before they can reflect light to provide an alarm. If there is no light irradiating the light-reflective zipper or the surroundings are dark, such as nighttime, there will be of no reflection of light and consequently no alarm be made. Further, in the daytime, due to the over-sufficiency of the ambient light, the reflected light from the light-reflective zipper cannot be easily noted and again, there will be of no prominent alarm effect.

In view of these problems, the present invention aims to provide a removable zipper that is combined with a light bar, can be readily assembled and removed, is resistant to water, can emit light for alarming purposes, and is controllable for light emission and flashing in order to improve the convenience of use.

### SUMMARY OF THE INVENTION

A primary object of the present invention is to provide a removable zipper that is combined with a light bar, can be readily assembled and removed, is resistant to water, can emit light for alarming purposes, and is controllable for light emission and flashing in order to improve the convenience of use.

To achieve the above object, the present invention provides a light bar-combined zipper, which comprises: a first tape; a second tape, which has an edge joinable to an edge of the first tape to constitute a removable zipper structure; a light bar, which is combined to the second tape; and a controller, which is connected to the light bar to supply electrical power to and selectively activate/deactivate the lighting of the light bar. As such, the functions of readily assembling and removal, water resistance, and lighting and alarming, and control of light emission and flashing can be realized to thereby improve the convenience of use and requiring no irradiation of light to generate light reflection for alarming purposes.

### BRIEF DESCRIPTION OF THE DRAWINGS

The present invention will be apparent to those skilled in the art by reading the following description of preferred embodiments thereof with reference to the drawings, in which:

FIG. 1 is a schematic view illustrating a removable zipper according to a first embodiment of the present invention;

FIG. 2 is a schematic view showing the first tape of FIG. 1 mounted to a first slip and the second tape being actually removed;

FIG. 3 is a schematic view showing the second tape of FIG. 2 detached from a light bar and a positioning piece;

FIG. 4 is a schematic view showing the controller of the first embodiment is removably connected to the connection section of the light bar;

FIG. 5 is an exploded view showing the controller of FIG. 4;

FIG. 6 is a cross-sectional view showing the removable zipper of first embodiment used in combination with a first slip and a second slip;

FIG. 7 is a schematic view showing a removable zipper according to a second embodiment of the present invention;

FIG. 8 is a schematic view showing the removable zipper of the second embodiment used in combination with a first slip and a second slip.

### DETAILED DESCRIPTION OF THE PREFERRED EMBODIMENTS

### First Embodiment

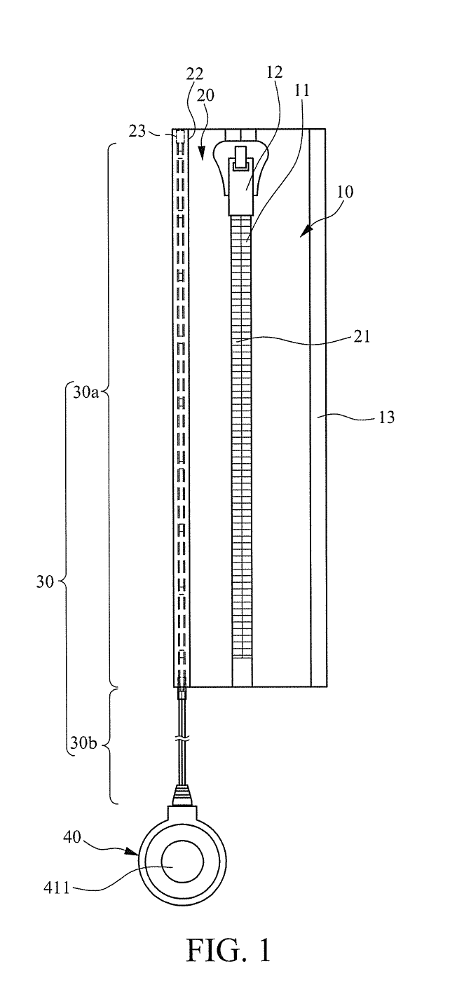

Referring to FIGS. 1-6, a light bar-combined removable zipper according to the present invention comprises a first tape 10, a second tape 20, a light bar 30, and a controller 40. The second tape 20 has an edge that is joinable to an edge of the first tape 10 to constitute the removable zipper. The light bar 30 is combined to the second tape 20. The controller 40 is connected to the light bar 30 to supply electrical power to and selectively activate/deactivate the lighting of the light bar 30.

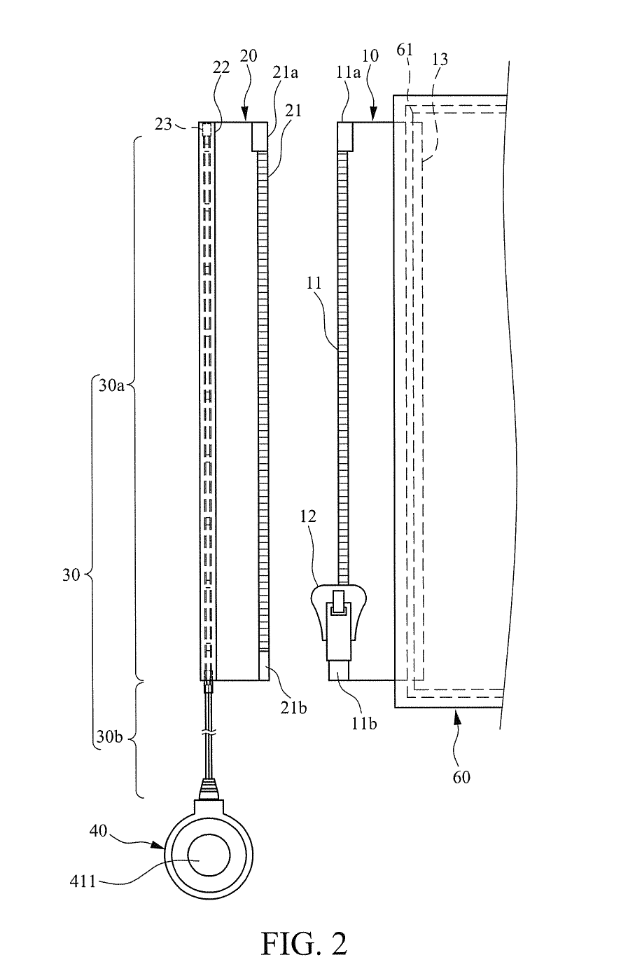

In the first embodiment, as shown in FIG. 2, the first tape 10 comprises an edge to which a first tooth row 11 and a first slider 12 are mounted. The first slider 12 is movably coupled to and reciprocally slidable along the first tooth row 11. The first tooth row 11 has two opposite ends to which stops 11a, 11b are respectively mounted to prevent the first slider 12 from undesired separation. The second tape 20 comprises a second tooth row 21 formed along an edge thereof. The second tooth row 21 has an end to which a stop 21a functioning to prevent undesired separation is provided and an opposite end to which an insertion pin 21b is mounted for engagement with the stop 11b of the first tooth row 11 to allow of reciprocal sliding motion of the first slider 12 and also allow of selective engagement and disengagement of the second tooth row 21 and the first tooth row 11 thereby achieving the effect of assembling and removal.

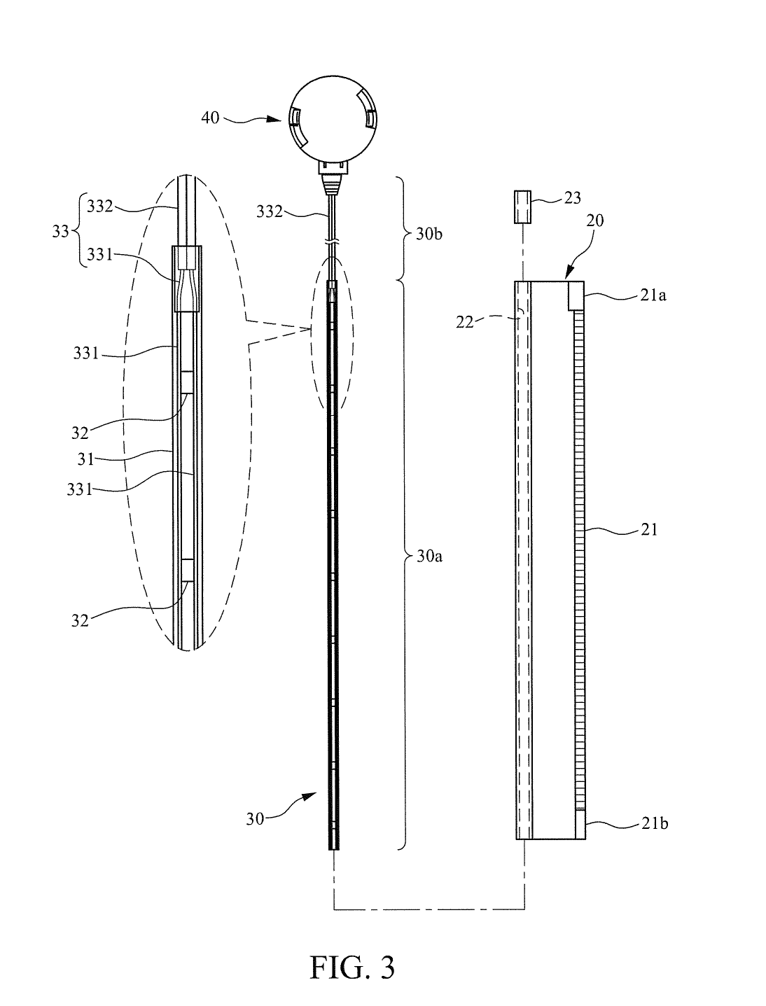

Referring to FIG. 3, the second tape 20 forms at least one receiving channel 22, in which the light bar 30 is received and fixed. The light bar 30 comprises a light-transmitting enclosure 31, a plurality of light-emitting diodes 32, and two conductive wires 33. Each of the conductive wires 33 comprises a plurality of metal filaments and is divided into a conduction segment 331 (only containing the metal filaments) and a connection segment 332 (containing the metal filaments and an insulation surface layer enclosing the metal filaments). The light-emitting diodes 32 are arranged, in a spaced manner, between and in electrical connection with the two conduction segments 331 and are received collectively in the light-transmitting enclosure 31 to be enclosed and fixed thereby to form a water-resistant light emission section 30a of the light bar 30, which besides ensuring these constituent components fixed in position, provides a function of water resistance. Further, the water-resistant light emission section 30a is received in the receiving channel 22 and retained therein. The two connection segments 332 are arranged to juxtapose each other to form a connection section 30b of the light bar 30 to be connected to the controller 40. The controller 40 can be directly and fixedly connected to the light bar 30, or alternatively, in a practical application, a detachable connection can be formed. The water-resistant light emission section 30a of the light bar 30 can be fixed is various ways, such as sewing, bonding with hot melt adhesive, bonding with adhesives, and the likes. In an application, it can be arranged to not fix in the receiving channel 22 and is rather sewn directly to and thus fixed to the second tape 20. The light-transmitting enclosure 31 is of a flexible structure, allowing arbitrary flexing with the tape in order to facilitate the use thereof.

The receiving channel 22 has an end to which a positioning piece 23 is mounted to retain the water-resistant light emission section 30a of the light bar 30 in position. The positioning piece 23 is embodied as a thermal shrinkable flexible tube and, after being heated, the positioning piece 23 may bond the water-resistant light emission section 30a of the light bar 30 to the receiving channel 22 of the second tape 20.

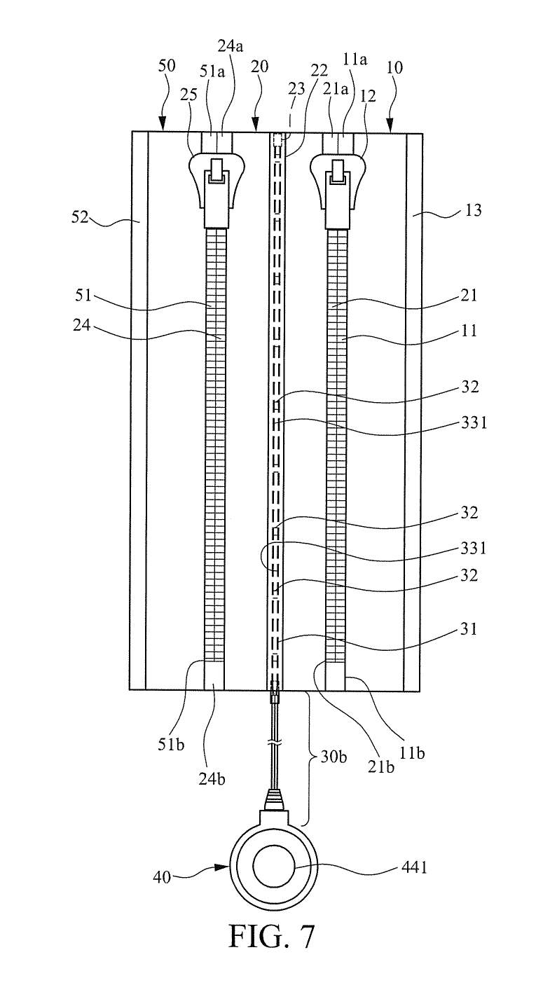

According to the present invention, the receiving channel 22 can be arranged at an opposite edge of the second tape 20 or can alternatively arranged in a body of the second tape 20 between the two opposite edges thereof (see FIG. 7). The receiving channel 22 forms access openings at two ends of the second tape 20. One of the access openings receives and retains the positioning piece 23 and another one receives the entry of the water-resistant light emission section 30a of the light bar 30 to bond to the positioning piece 23. Besides being a tube that is fixed through hot melting, the positioning piece 23 can be a tube that is fixed by sewing in order to fit to and retain the water-resistant light emission section 30a.

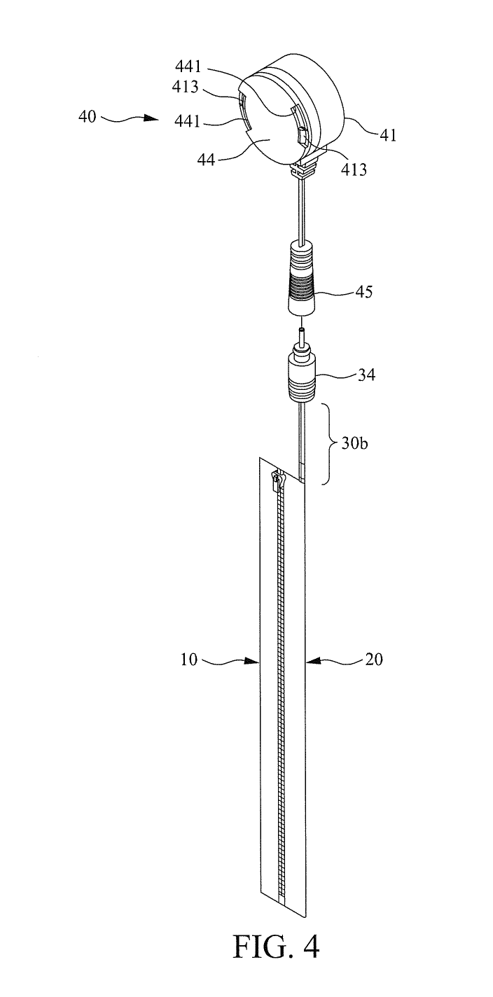

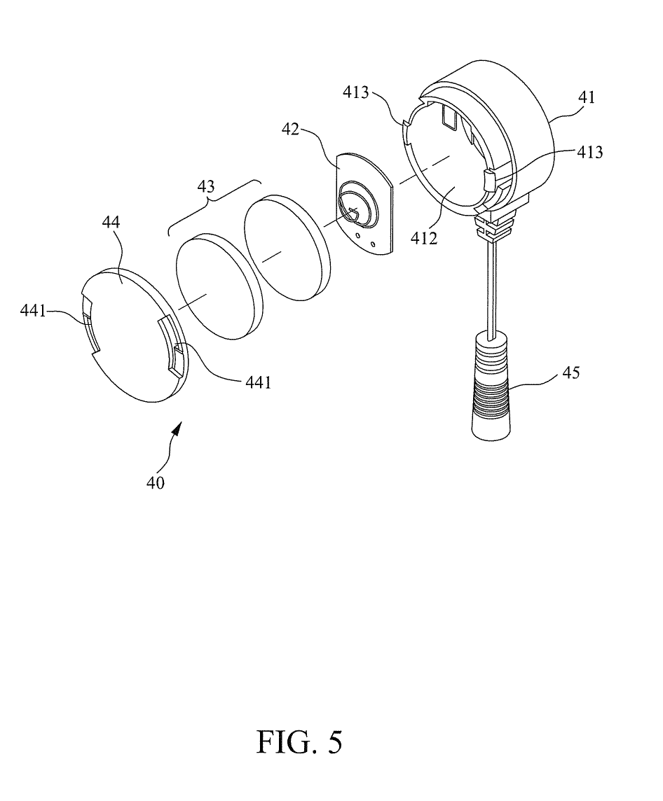

Referring to FIGS. 4 and 5, the controller 40 comprises a base 41, an electrical circuit board module 42, a battery set 43, and a cover 44. The base 41 has a surface to which a pushbutton 411 (see FIG. 1) is mounted and the base 41 has an opposite surface forming a receiving chamber 412, and two retention structures 413 are formed on a rim of the receiving chamber 412 to be opposite to each other. The cover 44 forms on a circumference thereof two counterpart retention structures 441 that are opposite to each other. The counterpart retention structures 441 may respectively receive the retention structures 413 therein for engagement and retention. The electrical circuit board module 42 is received in the receiving chamber 412. One side of the electrical circuit board module 42 is connected to the pushbutton 411 and the light bar 30 (namely the connection section 30b), and the battery set 43 is mounted to and in electrical connection with an opposite side of the electrical circuit board module 42.

To operate the controller 40 to control the lighting fashion of the light bar 30, the pushbutton 411 is first depressed, and the light-emitting diodes 32 are activated to show a lighting mode of fast flashing (such as flashing with high frequency). Pressing down the pushbutton 411 again causes the light-emitting diodes 32 to show a lighting mode of slow flashing (such as flashing in low frequency). Pressing the third time causes the light-emitting diodes 32 to show a lighting mode of being not flashing. And, pressing the fourth time would cut off power supply to make the light-emitting diodes 32 not lighting.

Referring to FIG. 5, the counterpart retention structures 441 are generally hollow slots in the embodiment illustrated, and horizontal ribs are formed inside the hollow slots. The retention structures 413 are pawls that are receivable into the hollow slots and L-shaped grooves are formed in a circumferential wall of the base 41 to slidably receive the horizontal ribs to move therealong so as to rotate the cover 44 to open or close.

Referring to FIG. 4, the light bar 30 (namely the connection section 30b) further comprises a connector 34 (such as a male connector); and the controller 40 comprise at least one counterpart connector 45 (such as a female connector or a socket). The counterpart connector 45 is mateable with the connector 34 for releasable connection therebetween for the purposes of replacement and substitute. The counterpart connector 45 can be mounted to the circumferential side wall of the base 41 of the controller 40 to electrically connect to the electrical circuit board module 42 received inside the base 41, but not limited to such an arrangement. The counterpart connector 45 may alternatively be electrically connected to the electrical circuit board module 42 by extended conductive wires that are connected to the base.

The present invention can be mounted to an opening of general clothing or an accessory. As shown in FIG. 2, the first tape 10 has an opposite edge forming a first coupling zone 13, to which a first slip 60 is coupled. The first slip 60 has an edge forming a first counterpart coupling zone 61, which is fixed to the first coupling zone 13 by means of for example sewing or hot melting bonding. The first slip 60 can be an edge of clothing and accessory (such as an edge of clothing) or an opening portion (such as collar, cuff, and pocket). The clothing can be garments, trousers, skirts, headscarves, hats, socks, shoes, gloves, and mufflers, which are directly put on portions of a human body. The accessory can be a bag (such as purse and waist pack), towel (such as a napkin and handkerchief) or a sack (such as backpack or hand carrying bag), which are accessories for decoration and carrying.

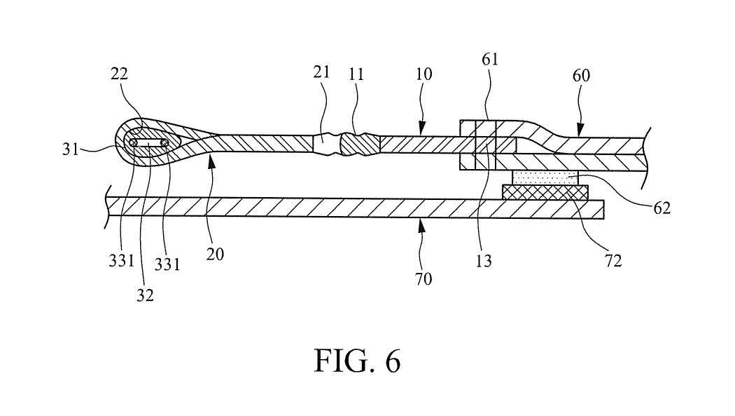

The opening portion is closable. When used in a garment that is open in the front side to form left and right panels (such as raincoat, jacket, and vest), the first slip 60 can be a portion of the left panel, while a second slip 70 is a portion of the right panel. As shown in FIG. 6, the first slip 60 is provided, on a surface thereof, with at least one first slip connection zone 62, while the second slip 70 is provided, on a corresponding surface thereof, with at least one second slip connection zone 72, whereby the second slip connection zone 72 and the first slip connection zone 62 are connected each other in such a way that the second tape 20 is not fixed and is thus allowed to freely move. This allows the second tape 20 of the light bar to be readily and efficiently removed even when the slips 60, 70 are fixed to each other or to be removed in washing and cleansing, in order to prevent the conductive wires from entangling to negatively affect the lighting functionality. The first slip connection zone 62 and the second slip connection zone 72 can be for example hook portion and loop portion of a hook-and-loop fastener, button and buttonhole, hook and eye, or ball side and socket side of snap.

### Second Embodiment

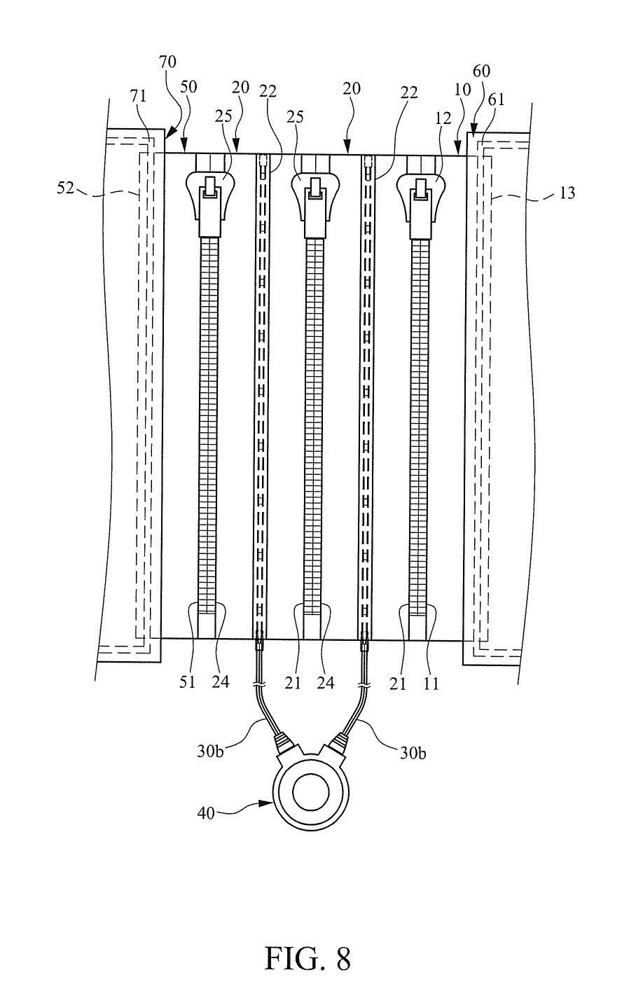

Referring to FIGS. 7 and 8, a removable zipper constructed in accordance with a second embodiment of the present invention is show, which is different from the above discussed first embodiment in that in this embodiment, the second tape 20 has an opposite edge to which a third tape 50 is connected. A second counterpart tooth row 24 and a second slider 25 are mounted to said opposite edge of the second tape 20 and the second slider 25 is movably coupled to and reciprocally slidable along the second counterpart tooth row 24. The second counterpart tooth row 24 has two opposite ends to which stops 24a, 24b are respectively mounted to prevent the second slider 25 from undesired separation. The third tape 50 comprises a third tooth row 51 formed along an edge thereof. The third tooth row 51 has an end to which a stop 51a, functioning to prevent undesired separation is provided and an opposite end to which an insertion pin 51b is mounted for engagement with the stop 24b of the second counterpart tooth row 24 to allow of reciprocal sliding motion of the second slider 25 and also allow of selective engagement and disengagement of the second counterpart tooth row 24 and the third tooth row 51 thereby achieving the effect of assembling and removal.

In second embodiment, as shown in FIG. 7, the opposite two edges of the second tape 20 are respectively provided with the first tape 10 and the third tape 50, whereby the first slider 12 may be selectively moved to close or open the second tape 20 and the first tape 10 or the second slider 25 may be selectively moved to close or open the second tape 20 and the third tape 50. By completely sliding the first slider 12 and the second slider 25 down to the very end, the second tape 20 can be removed. Once the second tape 20 is removed, the insertion pin 51b of the third tooth row 51 may be put through the first slider 12 and then inserted into and retained in the stop 11b of the first tooth row 11 to join together (not shown). Subsequently sliding the first slider 12 up, the third tooth row 51 and the first tooth row 11 are cause to engage each other to, thereby having the third tape 50 and the first tape 10 joined to each other. This improves the convenience of use and allows the second tape 20 of the present invention that comprises a light bar 30 to be used with a regular zipper and thus expanding the application of the present invention.

Referring to FIG. 8, between the second tape 20 and the third tape 50, there can be an additional second tape 20 connected thereto in order to increase the area where lighting and alarm can be perceived and to allow the light bars 30 of the second tapes 20 to be lit in different lighting modes to for eye catching and ready perception by bare eyes.

Further, in second embodiment, as shown in FIG. 8, the third tape 50 has an opposite edge forming a third coupling zone 52, to which the second slip 70 may be joined. The second slip 70 has an edge forming a second counterpart coupling zone 71, which is fixed to the third coupling zone 52 by means of for example sewing or hot melting bonding. In this way, when the left and right front panels of a garment can be joined to each other for closure, the two opposite edges of the second tape 20 are respectively connected to and fixed by the first tape 10 and the third tape 50, whereby the light bar 30 is located along the zipper of the front side of the garment to allow of easy eye identification in an environment of poor lighting. When the body size of user makes it hard to zip up the zipper, an additional second tape 20 can be further joined between the first tape 10 and the third tape 50 to adjust tightness of the clothing for comfortable wearing. The connection sections 30b (or the connectors) of the light bars 30 can be collectively connected to and controlled by a single controller 40.

The tapes, such as the first tape 10, the second tape 20, and the third tape 50, used in the present invention can be woven tapes or tapes with resiliency.

As such, the light bar-combined removable zipper according to the present invention employs a combination of a first tape 10, a second tape 20, a light bar 30, and a controller 40 to realize the functions of efficient assembling and removal, water resistance, lighting and alarming, and lighting and flashing control, so that the convenience of use is improved. And, between the light bar 30 and the controller 40, a connector 34 is provided for mating a counterpart connector 45 to allow of easy replacement and substitute of the controller 40.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light bar-combined removable zipper, comprising:
a first tape;
a second tape, which has an edge joinable to an edge of the first tape to constitute a removable zipper structure;
a light bar, which is combined with the second tape; and
a controller, which is connected to the light bar to supply electrical power to and selectively activate/deactivate lighting of the light bar.

2. The light bar-combined removable zipper as claimed in claim 1, wherein the first tape comprises an edge to which a first tooth row and a first slider is mounted, the first slider being movably coupled to and reciprocally slidable along the first tooth row, the first tooth row having two opposite ends to which stops are respectively mounted to prevent the first slider from undesired separation, the second tape comprising a second tooth row formed along an edge thereof, the second tooth row having an end to which a stop functioning to prevent undesired separation is provided and an opposite end to which an insertion pin is mounted for engagement with one of the stops of the first tooth row to allow of reciprocal sliding motion of the first slider and also allow of selective engagement and disengagement of the second tooth row and the first tooth row.

3. The light bar-combined removable zipper as claimed in claim 1, wherein the second tape forms at least one receiving channel, in which the light bar is received and fixed, the light bar comprising a light-transmitting enclosure, a plurality of light-emitting diodes, and two conductive wires, each of the conductive wires comprising a plurality of metal filaments and being divided into a conduction segment and a connection segment, the light-emitting diodes being arranged, in a spaced manner, between and in electrical connection with the two conduction segments and being received collectively in the light-transmitting enclosure to be enclosed and fixed thereby to form a water-resistant light emission section of the light bar, the water-resistant light emission section being received in the receiving channel and retained therein, the two connection segments being arranged to juxtapose each other to form a connection section of the light bar to be connected to the controller.

4. The light bar-combined removable zipper as claimed in claim 3, wherein the receiving channel has an end to which a positioning piece is mounted to retain the water-resistant light emission section of the light bar in position.

5. The light bar-combined removable zipper as claimed in claim 1, wherein the controller comprises a base, an electrical circuit board module, a battery set, and a cover, the base having has a surface to which a pushbutton is mounted and the base having an opposite surface forming a receiving chamber, two retention structures being formed on a rim of the receiving chamber to be opposite to each other, the cover forming on a circumference thereof two counterpart retention structures that are opposite to each other, the counterpart retention structures respectively receiving the retention structures therein for engagement and retention, the electrical circuit board module being received in the receiving chamber, one side of the electrical circuit board module being connected to the pushbutton and the light bar, the battery set being mounted to and in electrical connection with an opposite side of the electrical circuit board module.

6. The light bar-combined removable zipper as claimed in claim 1, wherein the light bar comprises a connector and the controller comprise at least one counterpart connector, the counterpart connector being mateable with the connector for releasable connection therebetween.

7. The light bar-combined removable zipper as claimed in claim 1, wherein the first tape has an opposite edge forming a first coupling zone, to which a first slip is coupled, the first slip having an edge forming a first counterpart coupling zone, which is fixed to the first coupling zone.

8. The light bar-combined removable zipper as claimed in claim 7, wherein the first slip is connectable to a second slip, the first slip being provided, on a surface thereof, with at least one first slip connection zone, and the second slip being provided, on a corresponding surface thereof, with at least one second slip connection zone, whereby the second slip connection zone and the first slip connection zone are connected each other.

9. The light bar-combined removable zipper as claimed in claim 8, wherein the first slip and the second slip are respectively two opposing portion of one of garments, trousers, skirts, headscarves, hats, socks, shoes, gloves, mufflers, towels, scarves, and bags.

10. The light bar-combined removable zipper as claimed in claim 1, wherein the second tape has an opposite edge to which a third tape is connected, a second counterpart tooth row and a second slider being mounted to said opposite edge of the second tape, the second slider being movably coupled to and reciprocally slidable along the second counterpart tooth row, the second counterpart tooth row having two opposite ends to which stops are respectively mounted to prevent the second slider from undesired separation, the third tape comprising a third tooth row formed along an edge thereof, the third tooth row having an end to which a stop, functioning to prevent undesired separation, is provided and an opposite end to which an insertion pin is mounted for engagement with the stop of the second counterpart tooth row to allow of reciprocal sliding motion of the second slider and also allow of selective engagement and disengagement of the second counterpart tooth row and the third tooth row.

11. The light bar-combined removable zipper as claimed in claim 10, wherein further arranged between the second tape and the third tape is an additional second tape of the same structure.

12. The light bar-combined removable zipper as claimed in claim 10, wherein the first tape has an opposite edge forming a first coupling zone, to which a first slip is coupled, the first slip having an edge forming a first counterpart coupling zone, which is fixed to the first coupling zone; and the third tape has an opposite edge forming a third coupling zone, to which the second slip is joined, the second slip having an edge forming a second counterpart coupling zone, which is fixed to the third coupling zone.

13. The light bar-combined removable zipper as claimed in claim 12, wherein the first slip and the second slip are respectively two opposing portion of one of garments, trousers, skirts, headscarves, hats, socks, shoes, gloves, mufflers, towels, scarves, and bags.

14. The light bar-combined removable zipper as claimed in claim 10, wherein the first tape, the second tape, and the third tape are tape with resiliency.
